(19) United States
(12) Patent Application Publication
(10) Pub. No.: US 2002/0069366 A1
(43) Pub. Date: Jun. 6, 2002

(54) Tunnel mechanis for providing selective external access to firewall protected devices

(76) Inventor: Chad Schoettger, Louisville, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 09/728,257

(22) Filed: Dec. 1, 2000

(51) Int. Cl. H04L 9/00

(52) U.S. Cl. 713/201; 709/227

(57) ABSTRACT

A method for providing an external client access to a device that is protected by a firewall. The method includes providing a tunnel mechanism and then operating the tunnel mechanism to receive an access request to the device from the external client. The tunnel mechanism verifies the external client is currently authorized to access a host device. If authorized, the method continues with routing the access request to the device. The verifying step may include determining a level of authorization and then the routing step is performed based on the determined level of authorization. The routing step includes modifying the access request to include an address of an interface of the internal device. The method continues with receiving a response to the modified access request from the internal device and then modifying the response to remove any identification information for the internal device included in the response.

### BACKGROUND OF THE INVENTION

1. Field of the Invention

The present invention relates, generally, to data communication in networks utilizing security software and hardware, and, more particularly, to a system, method, and architecture for providing external access through an existing port or access node in a firewall to internal computer devices and systems hidden or protected behind the firewall and a host.

2. Relevant Background

Firewalls are a combination of hardware and software that limits the exposure of a computer or computer systems, such as servers and file systems, to an attack from external devices. Firewalls are commonly used on a local area network (LAN) connected to the Internet to form a boundary that limits access between the internal LAN and the Internet. The primary purpose of an Internet firewall is to provide a single point of entry or port where a defensive mechanism can be implemented that allows internal devices to readily access resources on the Internet while providing controlled access from the Internet side of the firewall to a host Web server and other devices in the internal network.

A traditional firewall may be implemented with a router that controls traffic at the packet level, allowing or denying packets based on the source of the packet and the destination address of the port number (i.e., packet filtering). The firewall provides a method for tightly controlling access or entry through the single entry port to a host. Once access to the host, e.g., a Web server, is achieved, further security is provided by authenticating the access request with the host Web server. The host Web server may execute a login procedure that matches the client (i.e., the requester) and their identification information with an access control list. For example, students registered for an online class may be placed on an access control list for access as a student to a host Web server or a system administrator may be placed on an access control list for access to a host Web server as an administrator.

While firewall security is necessary to protect internal devices from attack by unauthorized users, firewalls also function to block desirable access by authorized users, such as system administrators, to internal computer devices, such as HyperText Transfer Protocol (HTTP) servers, application servers, database management systems, and the like. Because there is only one entry point through the firewall, authorized users are limited to accessing the host Web server. Often, direct access to the hidden, internal computer devices is physically impossible or involves complex login and encryption processes that significantly reduce performance. Additionally, when access is granted to these restricted computer devices, it is desirable that the mechanism providing access also provide error support by either correcting the problem or passing the error message to the requester in a useable form. Accordingly, there is a need to improve access to internal devices hidden by a firewall in a selective and secure manner that facilitates maintenance of these devices and enhances client service and use (i.e., authorized use) without creating additional entry points or holes in the firewall or otherwise decreasing network security.

Some efforts have been made to address accessibility problems, but these efforts have had only limited success. For example, access to restricted systems or devices is sometimes provided by including in a firewall an HTTP proxy server configured to grant specific users access to the restricted devices. In this example, when an external request is received at the firewall, it is routed to the proxy server. The proxy server then acts as a relay service by wrapping new headers around messages from the outside and sending them to the internal devices while preventing direct access to the internal devices. However, the proxy server does not verify whether the requester or client device is authorized to login to the host Web server, and, consequently, provides less authentication and security then a traditional firewall. In general, proxy servers also fail to provide support for translating error messages from restricted-access devices and for resolving such errors. Other techniques for providing access to hidden devices create other problems such as relaxing firewall restrictions, requiring modification of application code to open non-standard ports (e.g., making more holes in the firewall), or requiring implementation of mechanisms on both the internal devices and the external requesting devices.

Accordingly, there remains a need for methods and systems for providing an external client access to internal computers and devices that are hidden or protected behind a firewall and a host. Preferably, such a method or system would provide high levels of network security by using the existing entry port through the firewall and by only granting the additional internal access to clients or requesting devices that are already authorized to access the host. Additionally, it is preferable that such a method or system would also support message translation of errors from the accessed devices and at least attempted correction of the errors.

### SUMMARY OF THE INVENTION

Briefly stated, the present invention provides a method for selectively and securely providing an external client with limited and hidden access to a computer device that is protected by a firewall. In a preferred embodiment, a host device is provided and is linked to an access or entry port of the firewall and to the computer device. The method includes installing a tunnel mechanism (such as a Java™ servlet) on the host device or elsewhere between the host device and the protected computer device. The method continues with the tunnel mechanism receiving an access request to the computer device from the external client. The tunnel mechanism then verifies that the external client is currently authorized to access the host device, e.g., in a logon session and the like. If the client is verified as authorized, the method continues with routing the access request to the computer device.

In one embodiment, the method further includes determining a destination interface from the information in the access request (such as when there is a plurality of computer devices) and modifying the access request to include address information for the destination interface. In another embodiment, the verifying step includes determining a level of authorization and then the routing step is performed based on the determined level of authorization to increase the control over the external client's access to protected computer devices. In a further embodiment of the method, responses to the access request are checked for error messages and any such error messages are translated by the tunnel mechanism and if readily resolvable, resolved by the tunnel mechanism.

According to another aspect of the invention, a method is provided for controlling access to a device on an internal communications network by a client device on an external communications network. In this method, the internal and external communications networks are separated by a firewall device, and significantly, the access to the internal device is hidden from the external device to increase security. The method begins with receiving with a tunnel mechanism an access request from the external client. Next, the access request is modified to include an address of an interface of the internal device. The tunnel mechanism is then operated to route the modified access request to the interface of the internal device. For example, in one embodiment, the access request includes URL information and the URL information for the internal device is included in the modified access request. The method continues with receiving a response to the modified access request from the internal device. Next, the tunnel mechanism functions to modify the response to remove any identification information for the internal device included in the response. In one embodiment, the removed identification information is replaced with identification information (such as URL information) for the tunnel mechanism, which not only hides the internal device from the external device but also gives the indication that the external client is accessing the tunnel mechanism.

According to yet another aspect of the invention, a network access system is provided for controlling access to a computer device, such as a server, protected by a firewall. The access system includes a host server on an interior side of the firewall communicatively linked to the firewall and the computer device. The host server is configured for communicating with the firewall and receiving a request from a client device located exterior to the firewall. The access system further includes a tunnel mechanism linked to the computer device adapted for: modifying the request to include an address of an interface of the computer device; routing the modified request from the computer device; receiving a response from the computer device including identification information; and modifying the response to remove the identification information. In one embodiment, the host server is an HTTP Web server configured to support Java™ and the tunnel mechanism is a Java™ servlet installed on the host server.

### BRIEF DESCRIPTION OF THE DRAWINGS

FIG. 1 is a block diagram of a firewall system in which a tunnel mechanism according to the present invention is implemented; and

FIG. 2 is a flow diagram depicting an exemplary method of the present invention for controlling access to the restricted-access devices, such as those in the firewall system of FIG. 1.

### DETAILED DESCRIPTION OF THE PREFERRED EMBODIMENTS

The present invention is directed to a method and system for providing selective, i.e., secure, access to servers and other computer devices in an internal network that is protected by a firewall. Typically, these devices are hidden behind a host, e.g., a Web server, that provides another layer of security by requiring the external clients to follow a login or other authentication procedure to demonstrate their level of approved access to the host. The invention is described mainly in terms of client-server communications on the Internet with hosts and internal, restricted devices that are HTTP servers but can readily be any type of server or other computer device that supports an interface which is known to the tunnel mechanism. Additionally, these servers are described as supporting the Java™ programming language and, particularly, the Java™ Servlet API. While providing an easily described and understood working example of the invention, this specific example is readily extendable to more general firewall applications in which a client is attempting to access any type of device with a tunnel mechanism-recognized interface that is protected by a firewall. Such general applications of the invention are considered to be within the breadth of the following description.

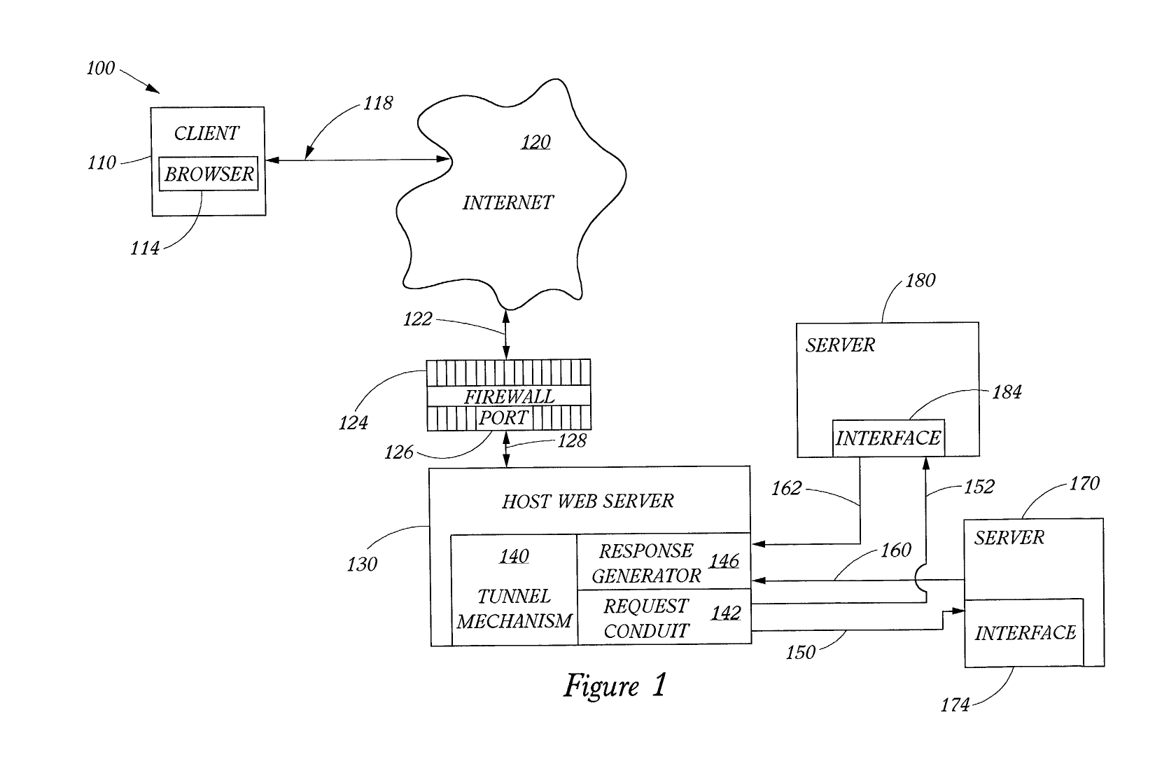

FIG. 1 illustrates a simplified firewall system 100 in which the present invention is usefully employed. A client 110, such as a personal computer or other electronic device with a display, a modem, and the like, is in communication via wired or wireless link 118 with the Internet 120 or other data communications network. Although only one client 110 is shown, the firewall system 100 could support numerous client devices. In this regard, the client 110 includes a browser 114 (e.g., a Web browser such as Netscape Navigator™) to allow the user of the client 110 to communicate with (i.e., “surf”) the Internet 120 and with devices linked to the Internet. In operation, the browser 114 typically uses HTTP or other protocol to make requests for documents and to view the returned documents (e.g., HyperText Markup Language (HTML) documents). The browser 114 is also useful for responding to requests from contacted devices for additional information, including login identification information and the like. The client 110 and the Internet 120 can be thought of as the external or outside portion of the firewall system 100.

The internal or inside and protected portion of the firewall system 100 is connected to the Internet 120 with communications link 122. A firewall 124, which may include any number of routers and other computer devices, is provided to process requests for information and/or access to internal devices and to narrowly limit access to devices on the internal side of the firewall 124. This protection may be provided in myriad ways, including at the packet level or the application level. In one embodiment of the firewall system 100, the firewall 124 functions to filter requests on the packet level based on a determination of the source of the request (e.g., is the source of the request an expected and authorized source) and on the destination of the request. In this regard, the firewall 124 includes a single port 126 or entry point to the internal, protected portion. Requests that are passed through the filter of the firewall 124 are passed through the port on link 128 to the internal, protected portion of the firewall system 100. Of course, the features of the invention can readily be expanded to a firewall with more than one entry point or port 126.

A host 130, illustrated as a host Web server, is provided to receive requests and other communications that are passed through the firewall 124 and to function as the input and output interface between the external and internal portions of the firewall system 100. While numerous host devices may be utilized, a preferred, but not limiting, embodiment for the host 130 is a Web server that supports Java™ and the Java™ Servlet API. The host Web server 130 further functions to add a layer of security by including processes for authenticating that the user of the client 110 has authority to access the host Web server 130. A number of authentication techniques may be used in this regard.

For example, in one embodiment, the host Web server 130 is operable to execute a login program, which requires the user of the client 110 to provide an identification code. If login is successful, the client is provided access to the host Web server 130. A level of access may also be established by the host Web server 130. For example, the user of the client 110 may low-level access, such as a student registered for an online class, or the user of the client 110 may have high-level access, such as a system administrator who is allowed to modify device configurations, alter files, and the like. The level of access typically would be determined at login by the user requesting a certain level of access and entering a proper key code or identification code.

According to a significant aspect of the invention, the host Web server 130 includes a tunnel mechanism 140 that functions as a secure interface between the host Web server 130 that can tunnel to or provide a conduit to normally hidden or unavailable devices. The tunnel mechanism 140 may comprise a software application or object, such as one a Java™ servlet, that is installed on the host Web server 130 (or alternatively, could be installed on a separate device in communication with the host Web server 130). The tunnel mechanism 140 functions to monitor incoming requests for documents and/or access to hidden or restricted devices. When a request is made to a device for which tunnel mechanism 140 has established a link and an interface, the tunnel mechanism 140 is invoked and first verifies that the request is being made as part of an authenticated login session, i.e., the user of the client 110 is currently logged onto the host Web server 130. If authenticated, then the tunnel mechanism 140 forwards the request to a linked, restricted device.

As illustrated, the firewall system 100 includes two servers 170, 180 (i.e., hidden devices), and consequently, the tunnel mechanism 140 functions to determine the appropriate destination interface 174, 184 for forwarding the request from the client 110. This determination is typically completed by examination of the URL of the request. Alternatively, any number of other mechanisms may be used to complete this determination and are considered part of the invention. For example, the routing may be based on the client 110 that makes the request based on HTTP header information rather than on an examination of the request URL. The tunnel mechanism 140 includes a request conduit 142 for routing the request to the proper destination interface 174, 184. The servers 170, 180 may be any type of servers, such as HTTP servers, application servers, database management and file servers, and the like. Additionally, other computer devices and systems may be present in the internal portion of the firewall system 100 and the number of these devices may vary significantly (e.g., 1 or 2 or more).

The tunnel mechanism 140 is linked to the servers 170 and 180 with links 150, 160 and 152, 162, respectively. Two links are illustrated for ease of description of data flow, but it should be understood that typically a single connection line would be provided for each server 170, 180. The request conduit 142 of the tunnel mechanism 140 transmits requests via links 150 and 152 to the interfaces 174 and 184 of the servers 170 and 180. The returned document or response is transmitted from the servers 170, 180 on links 160 and 162 to a response generator 146 of the tunnel mechanism 140.

The response generator 146 provides several important functions for the tunnel mechanism 140. The response generator 146 first determines if any error messages were transmitted from the interfaces 174, 184 of the servers 170, 180. If an error message was received in response to the request from the request conduit 142, the response generator 146 translates the error message and determines if the error is readily correctable or resolvable (e.g., a redirect code and the like). If resolvable, the tunnel mechanism 140 may invoke the appropriate objects or software applications (not shown) to address the error. If not readily resolvable, a translation of the error message is returned as part of the response to the client 110.

According to a significant aspect of the invention, the response generator 146 also provides the function of hiding the servers 170 and 180 from the client 110. In other words, the response generator 146 is configured to prepare a response that appears to have originated at the host Web server 130 and/or at the tunnel mechanism 140. The interaction with the servers 170, 180 is not visible to the client 110, and specifically, the address or location (e.g., URL) of the servers 170, 180 is not provided to the client 110 to enhance the security of the firewall system 100. The response generator 146 functions to modify the document, file, or other information returned from the servers 170, 180 such as by modifying the URL to point back to the host Web server 130, and more preferably, to the tunnel mechanism 140. In this manner, the user of the client 110 is never given the name or URL of the restricted server, i.e., a restricted internal device.

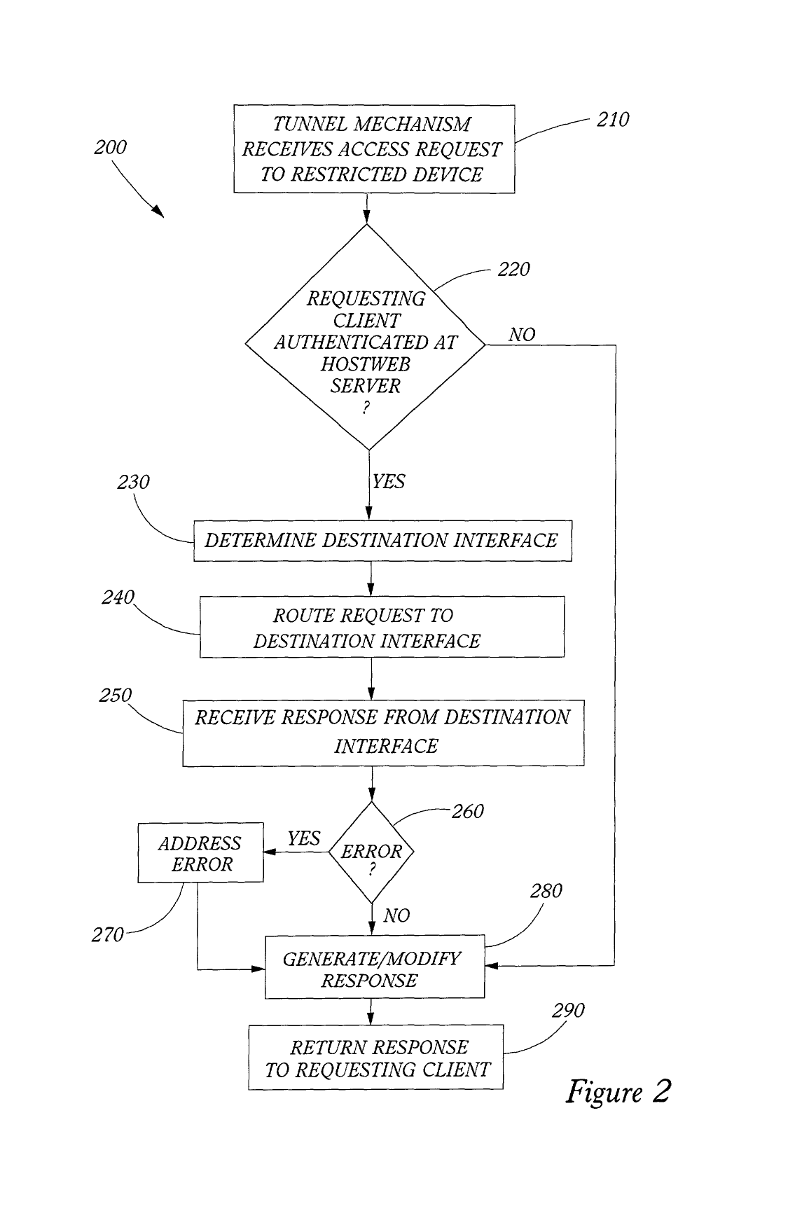

FIG. 2 illustrates a method 200 of selectively providing access to devices behind a firewall according to the present invention. These steps are generally performed by the tunnel mechanism 140 during operation of the firewall system 100. Once installed on a host Web server 130, the method 200 begins at 210 with the tunnel mechanism 140 monitoring for requests to the restricted device (such as servers 170, 180). The request may simply include the URL of the restricted device and the information or document requested. In a more preferred embodiment, the user operates browser 114 to invoke the tunnel mechanism 140 and passes the URL command to be passed to the restricted (and hidden) device. For example, if the host Web server 130 and server 170 are HTTP servers and the request is for an HTML document, the URL may be:

http://hostwebserver130.com/servlet/tunnelmechanism/html/document1.html, where “document1.html” is located on server 170.

At 220, the tunnel mechanism 220 communicates with the host Web server 130 to determine whether the source of the request is a client 110 that has been authenticated. In one embodiment, once the client 110 is authenticated for access to the host Web server 130, the client 110 is granted access by the tunnel server 140 to every hidden device for all purposes (e.g., read only, read and write, system configuration). In another embodiment, different levels of access are assigned at login by the host Web server 130. The tunnel mechanism 140 then uses these levels of access to determine which restricted devices, or even which files or portions within the restricted devices, can be accessed by the client 110. For example, a user, such as a student, may only be able to access the restricted devices supporting the classes for which they are registered whereas a system administrator may be granted access to every device and for all purposes. Note, although only one tunnel mechanism 140 is shown, more than one tunnel mechanism 140 could be included to provide and control access to the different restricted devices or to the differing levels of users who access the host Web server 130. At 220, if the client 110 is not authenticated or logged in to the host Web server 130, a response is generated at 280 informing the client 110 that access is denied to the requested information (e.g., the message may indicate that the client 110 needs to follow proper login procedures and the like).

If the client 110 is authenticated at 220, the method continues at 230 with the tunnel mechanism 140 determining the proper destination interface to transmit the request. If there is only one restricted server, the request will be transmitted to that server as the request document must be available through that device or not be available at all. If there are more than one hidden servers or devices, however, the request conduit 142 is invoked to determine which of the servers 170, 180 contains the document such as with a query to each device or by simply transmitting the request to both servers 170, 180.

At 240, the request conduit 142 routes the request to the destination interface 174 or 184 via links 150 or 152. As part of this function, the request conduit 142 modifies the request (e.g., the URL) so as to properly access the selected destination interface 174, 184. For the above example, the request conduit 142 would modify the URL to: http://server170.com/html/document1.html and then transmit the request to the interface 174 of server 170.

The tunnel mechanism 140 then waits for a response from the server 170, which is received at the response generator 146 at step 250. At 260, the response generator 146 determines if the response includes an error (e.g., an HTTP or other protocol error code). If an error is detected, the response generator 146 and/or the tunnel mechanism 140 preferably translates the message code and calls applications or objects (not shown) to attempt to resolve the error at 270. In order to resolve the error at 270, additional communication may take place between steps 240 and 250. For example, if an HTTP redirect response is received at 250, the tunnel mechanism 140 preferably makes an additional request of the destination device (e.g., repeats at least part of step 240) for the location to which the request has been redirected. At 280, the response generator 146 operates to create a response to return to the client 110. If an error was unresolvable, the response includes a statement regarding the content of the error message without indicating the name or address of the hidden device.

At 280, the response generator 146 functions to generate a response that can be returned to the client 110 that provides the requested information while indicating that the source was the host Web server 130 or the tunnel mechanism 140. For the above example, the response generator 146, which may comprise a page generator application or object, may receive a URL from the interface 174 of:

http://ultraseek/server170/documentl.html but then alter the URL to:

http://searchengineofhostwebserver/tunnelmechanism/d ocument1.html.

At 290, this modified response is transmitted to the requesting client 110 from the host Web server 130. The response generator 146 is functional to modify (i.e., remove references to the restricted server 170) the URL to provide the appearance to the client 110 that the request has been satisfied by the host Web server 130 and the tunnel mechanism 140. The client 110 is not aware that it was given selective or limited access to the restricted server 170. Further, the tunnel mechanism 140 is effective for creating an interface with the particular search engine of the server 170, 180 to locate the requested document.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method for providing an external client with selective access to a computer device protected behind a firewall and a host, comprising:
providing a tunnel mechanism between the host and the computer device, wherein the tunnel mechanism is in communication with the host and the computer device;
receiving with the tunnel mechanism an access request to the computer device from the external client;
verifying the external client currently has authorized access to the host; and
after successful completion of the verifying, routing the access request to the computer device with the tunnel mechanism.

2. The method of claim 1, further including prior to the routing, determining a destination interface from the access request and wherein the routing includes modifying the access request to include an address for the destination interface.

3. The method of claim 2, wherein the providing includes establishing a communicative link between the tunnel mechanism and the destination interface.

4. The method of claim 1, further including receiving a response to the access request from the computer device and modifying the response prior to transmitting the response to the external client to remove identification information for the computer device.

5. The method of claim 4, wherein the modifying includes adding identification information for the tunnel mechanism to the response.

6. The method of claim 5, wherein the response includes URL information and the added identification information includes URL information for the tunnel mechanism.

7. The method of claim 4, further including examining the response for an error message, translating the error message, and including the error message in the response transmitted to the external client.

8. The method of claim 7, further including operating the tunnel mechanism to take corrective actions to remove the error message from the response from the computer device.

9. The method of claim 1, wherein the verifying includes determining a level of the authorized access and, further wherein the routing includes limiting the access request to the computer device to the determined level of the authorized access.

10. A method for controlling access to a device on an internal network by a client device on an external data communications network, a firewall being installed between the internal network and the external data communications network, the method comprising:
receiving with a tunnel mechanism an access request from the external client device to the internal network device, the tunnel mechanism being communicatively linked to the firewall and an interface of the internal device;
modifying the access request to include an address of the interface of the internal device;
operating the tunnel mechanism to route the modified access request to the interface of the internal device;
receiving a response to the modified access request from the internal device at the tunnel mechanism, the response including identification information for the internal device; and
modifying the response with the tunnel mechanism to remove the identification information prior to transmittal of the modified response to the external client device.

11. The method of claim 10, wherein the access request includes URL information and the access request modifying includes modifying the URL information to include URL information for the internal device.

12. The method of claim 10, wherein the identification information includes URL information for the internal device and the response modifying includes replacing the internal device URL information with URL information for the tunnel mechanism.

13. The method of claim 10, wherein the internal network includes a plurality of the internal devices, and the access request modifying includes determining a destination interface for a one of the internal devices corresponding to the access request from the external device.

14. The method of claim 10, further including prior to the routing, verifying the external device is currently authenticated as an authorized user of a host device communicatively linked to the firewall and the tunnel mechanism.

15. The method of claim 14, wherein the host device is a HTTP Web server configured to support Java™ and the tunnel mechanism comprises a Java™ servlet.

16. A network access system for controlling access to a computer device protected by a firewall, comprising:
a host server on an interior side of the firewall, the host server being linked to the firewall and configured for receiving a request from a client device located exterior to the firewall; and
a tunnel mechanism linked to the computer device adapted for: modifying the request to include an address of an interface of the computer device; routing the modified request to the computer device; receiving a response from the computer device including identification information; and modifying the response to remove the identification information.

17. The system of claim 16, wherein the host server is a HTTP Web server configured to support Java™ and the tunnel mechanism is a Java™ servlet installed on the host server.

18. The system of claim 16, wherein the tunnel mechanism is further adapted for verifying, prior to the routing of the modified request, that the client device was authorized to access the host server when the request was received.

19. A computer program for providing a device on an exterior side of a firewall selective access to a device on the interior side of the firewall, a host being positioned between the firewall and the interior device, comprising:
first computer code devices configured to cause a computer to receive a request from the exterior device to access the interior device;
second computer code devices configured to cause a computer to verify the that the exterior device is presently authorized to access the host; and
third computer code devices configured to cause a computer to route the request to an interface of the interior device based on the verified authorization.

20. The computer program of claim 19, wherein the routing includes determining the interface for routing the request and the routing of the request includes modifying the request to include an address for the determined interface.

21. The computer program of claim 19, further including fourth computer code devices configured to cause a computer to receive a response from the interior device comprising identification information corresponding to the interior device and fifth computer code devices configured for causing a computer to generate a modified response based on the received response including removing the identification information.

22. The computer program of claim 21, further including sixth computer code devices configured to cause a computer to translate error messages in the received response, to take response actions to the error messages, and to include unresolved ones of the translated error messages in the modified response.
